(19) United States
(12) Patent Application Publication
(10) Pub. No.: US 2006/0224943 A1
(43) Pub. Date: Oct. 5, 2006

(54) Method and system to automatically publish media assets

(75) Inventors: Randall Adam Snyder, Las Vegas, NV (US); Sean Edward Moore, San Marcos, CA (US); Tomislav Petrovic, Carlsbad, CA (US); Scott Richard Crowder, Carlsbad, CA (US); Edward George Gross JR., Fountain Valley, CA (US)

Correspondence Address: SCHWEGMAN, LUNDBERG, WOESSNER & KLUTH, P.A., P.O. BOX 2938, MINNEAPOLIS, MN, 55402, US

(73) Assignee: Entriq Inc.

(21) Appl. No.: 11/261,254

(22) Filed: Oct. 28, 2005

Related U.S. Application Data
(60) Provisional application No. 60/667,553, filed on Apr. 1, 2005.

(51) Int. Cl. G06F 15/00

(52) U.S. Cl. 715/501.1

(57) ABSTRACT

A method and system to publish content for at least one remote electronic device are provided. The method may include providing a content provider with an interface to directly provide content for publishing by a content publishing system and automatically ingesting the content into the content publishing system. Thereafter, the content may automatically be made available to the remote electronic device. The content may be made available via a wireless data network (e.g., a cellular telephone network) to a plurality mobile devices (e.g., cellular telephones). As the media assets can be automatically ingested and automatically published, the content provided can directly publish content without further human intervention. Media assets may be added to a folder utilizing a drag-and-drop action or cut-and-paste action facilitated by an computer operating system. A control file including policy data and a metadata file may be associated with each media asset file.

### CLAIM OF PRIORITY

The present patent application claims the priority benefit of the filing date of U.S. Provisional Application Ser. No. 60/667,553 filed Apr. 1, 2005, the entire content of which is incorporated herein by reference.

### TECHNICAL FIELD

The present application relates generally to the technical field of publishing of uploading digital media to a content distribution network. For example, an embodiment of the invention relates to automatically publishing media assets to a content distribution network deployed in a wireless communication network.

### BACKGROUND

Content provider typically creates digital assets which they need to publish in order to make them available to end users. Examples of such digital assets in a television environment may be a video asset in the form of a movie that a user may purchase or receive based on a subscription arrangement. Thus, content providers (E.g., Disney, NOOF, MTV, and the like) provide content to a distribution facility and the distribution facility uploads the content and personnel at the distribution facility perform all the necessary operations to make the content available to users. It should be noted that the content provider in not able to independently upload the content but merely communicated it to the distribution channel for uploading.

With the explosive growth in the cellular or mobile phone industry, content or media assets are now being communicated via content distribution facilities to mobile devices via a cellular network. For example, mobile device users can down load media assets such as ring tones, wallpaper, video, audio tracks or any other digital media to their mobile devices. However, the content or media asset providers cannot upload or manage digital assets directly but merely supply digital assets to a cellular content distribution facility that then perform these tasks.

### SUMMARY

A method and system to automatically publish content via a content distribution network is provided.

The invention extends to a machine-readable medium for performing any one or more of the methodologies described herein.

Other features will be apparent from the accompanying drawings and from the detailed description that follows.

### BRIEF DESCRIPTION OF THE DRAWINGS

Embodiments of the present invention are illustrated by way of example, and not limitation, in the figures of the accompanying drawings, and in which like references indicate the same or similar elements.

In the drawings,

FIG. 1 shows architecture of an example networked system in which content is automatically published;

FIG. 2 shows functional entities of an example content publishing system to publish content to a plurality of mobile devices via a wireless network;

FIG. 3 shows an example embodiment in which content added to content folders is automatically ingested into a content distribution system;

FIG. 4 shows example corresponding folders provided on a mobile device and on a content publishing system;

FIG. 5 shows an example method to automatically ingest and publish content in a content publishing system;

FIG. 6 shows an example of a basic method to process uploaded content based on a control file;

FIG. 7 shows an example of a more detailed method to process uploaded content based on a control file;

FIG. 8 shows an example method of adding content to a content folder using a browser-based graphical user interface;

FIG. 9 shows an example method of automatically publishing the availability of content ingested into the content distribution network where the content is downloadable using a URL;

FIG. 10 shows an example method of checking digital rights associated with content in response to user selection of a URL associated with the content;

FIG. 11 shows an example graphical user interface showing metadata associated with a media asset;

FIG. 12 shows an example graphical user interface of control data associated with a folder including one or more media assets;

FIG. 13 shows an example graphical user interface showing folders provided on a content provider computer and at a content publishing system;

FIG. 14 shows an example graphical user interface where a new media asset has been added to a content publishing system for automatic content publishing;

FIG. 15 shows an example graphical user interface of a content management system prior to publishing a new media asset;

FIG. 16 shows an example graphical user interface of metadata associated with a media asset; and

FIG. 17 shows a diagrammatic representation of a machine in the example form of a computer within which a set of instructions for causing the machine to perform any one or more of the methodologies discussed herein, may be executed.

### DETAILED DESCRIPTION

A method and system to automatically publish or distribute content are described. In the following description, for purposes of explanation, numerous specific details are set forth in order to provide a thorough understanding of an embodiment of the present invention. It will be evident, however, to one skilled in the art that the present invention may be practiced without these specific details. Merely by way of example, the content may be digital assets such as still pictures/photographs, video, audio (e.g. ring tones) or any other digital media which may be automatically published to a mobile device (e.g., a cellular telephone). For example, the mobile device may communicate via any wireless network (e.g., a cellular telephone network, a wireless Internet connection, or the like).

Embodiments of the present invention may be utilized in conjunction with components of a system to distribute content as described in co-pending U.S. application Ser. No. 10/321,075, entitled ‘A METHOD AND SYSTEM TO SECURELY DISTRIBUTE CONTENT VIA A NETWORK’, and PCT application serial number PCT/US01/19271, entitled ‘METHOD AND SYSTEM TO DISTRIBUTE CONTENT VIA A NETWORK UTILIZING DISTRIBUTED CONDITIONAL ACCESS AGENTS AND SECURE AGENTS, AND TO PERFORM DIGITAL RIGHTS MANAGEMENT (DRM)’, each of which is incorporated herein in its entirety.

Reference numeral 10 generally shows architecture of an example networked system in which content is automatically published to at least one remote electronic device. The networked system 10 may include an automatic content publishing system 12 comprising, in an example embodiment, a bulk loader 14, a transcoder 16, a content management system (CMS) 18 which may define a content provider interface, a media server 20, and a device profile management system 21. The content management system 18 may have an associated content database 23 to store information or metadata about media assets that have been uploaded, the media server 20 may have an associated database 25 to store actual media assets after they have been transcoded and rendered suitable for communication to the mobile device 24 (e.g., via streaming), and the device profile management system 21 may have an associated device database 27 to store profile data associated with mobile devices that may be compatible with the content publishing system 12.

The content publishing system 12 may optionally include a content protection service 22 which communicates with a media authorization/billing network 29. In an example embodiment, the content publishing system 12 may enable content providers, or any automated computer-based system, to drop content (e.g. media assets) into a folder or directory for automatic ingestion into the content management system 18. The content or media assets may then automatically be made accessible (e.g., available for downloading) by a plurality of electronic devices 24. By way of example, the networked system 10 is described with reference to an electronic device in the form of a mobile device 24. The mobile device 24 may, for example, be any wireless device such as a mobile or cellular telephone, a Personal Digital Assistant (PDA), portable computer, or the like.

As described by way of example in more detail below, a content provider may automatically upload a media asset 26 via the Internet 28 to the content publishing system 12 which, in an automated fashion, may then publish the media asset (e.g., publish the availability of the media asset for downloading) to a plurality of mobile devices 24. For example, the content publishing system 12, may communicate content data or media asset data via a channel distribution server 30 to the Internet 28 which, in turn, communicates content data (data identifying what media assets are available) via a content delivery network 32 to a cellular wireless network 34. The wireless network 34 then communicates (e.g. via a wireless application protocol) information of the media assets available to the mobile device 24. In an example embodiment, a user of the mobile device 24 may then activate or click on a URL displayed on the mobile device 24 which, in turn, causes a selected media asset to be downloaded to the mobile device 24. However, it will be appreciated, that the ingestion of the media asset(s) into the content publishing system 12 is performed in an automated fashion without human intervention. Accordingly, a content provider using a remote personal computer may automatically make media assets available to the mobile device 24 directly via a remote content provider computer. Further, in an embodiment, the content provider may also edit and/or remove media assets that are currently being published by the networked system 10.

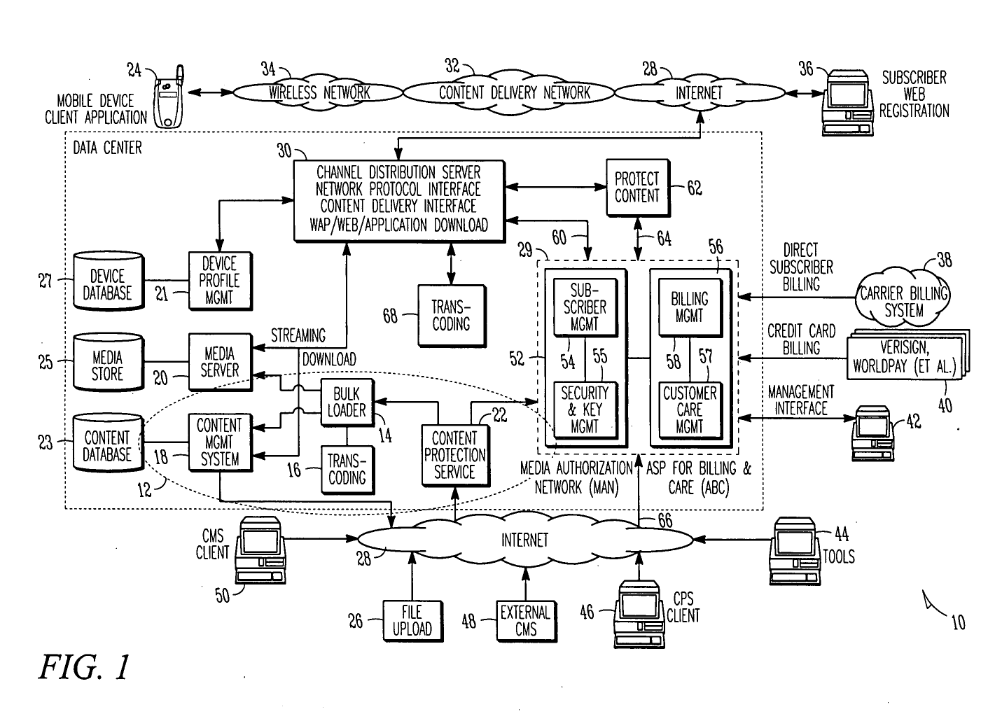

The networked system 10 of FIG. 1 is also shown to include, by way of example, a subscriber web registration computer 36 that allows subscribers to register for content that is published by the content publishing system 12. Further, when costs are associated with a media asset, a subscriber may be charged for the media asset and, accordingly, the networked system 10 includes a carrier billing system 38 that may allow direct subscriber billing, a credit card billing system 40 that allows credit card billing, and a management interface computer 42 to manage digital rights associated with each media asset available by the content publishing system 12. In addition, the networked system 10 may include a computer 44 which includes various tools to manage the networked system 10, and a content protection service (CPS) computer 46 including a content protection service client. Further, in an example embodiment, external content management system (CMS) data 48 may be provide to the content publishing system 12, and a content management system (CMS) computer 50 including a CMS client may also be provided.

The media authorization/billing network 29 may include a media authorization network (MAN) module 52 and an Application service Provider (ASP) module 56 for billing and customer care. The media authorization network module 52 may include a subscriber management module 54 and a security and key management module 55. The ASP module 56 may include a customer care management module 57 and a billing management module 58. The billing management module 58 and the customer care management module 57 may communicate with the carrier billing system 38, the credit card billing system 40, and the management interface computer 42. In use, the media authorization network 52 may communicate with the channel distribution server 30 (see arrow 60), with a content protection module 62 (see arrow 64), and with various other components via the Internet 28 as shown by arrow 66. In an embodiment, a transcoder 68 provides transcoding to the channel distribution server 30 to ensure that content or media assets are distributed in an appropriate format.

In an embodiment, the external content management system (CMS) data 48 is optionally provided. The external CMS data may be sourced from any external content management system owned or operated by a content provider or other entity. Application program interfaces (APIs) may be provided to enable an automated interface to the content management system 18. In an embodiment, the external CMS data 48 may support an automated API to allow bulk content uploads to the content management system 18 (which may reside locally or remotely). The uploaded content may be automatically ingested and uploaded into the content management system 18 and thereafter automatically published.

In order to facilitate bulk uploading, the bulk loader 14 is optionally provided to enable multiple content files to be registered with the content management system 18 in a single operation. In an embodiment, the transcoder 16 transcodes uploaded content prior to communication thereof to the content management system 18 and, thus, pre-transcoding of content may be provided to enhance performance. Thus, in an example embodiment, multiple media assets may be submitted along with associated metadata to the CMS 18. The bulk loader function may support transcoding of content prior to uploading thereof into the CMS 18. Content transcoded prior to ingestion into the CMS 18 may be transcoded into formats that are common to mobile devices supported for a given customer (e.g., transcoding all videos into H.263 format as this format is supported on all 3G-based mobile devices).

Thus, the transcoder 16 may transform individual media assets into an appropriate or suitable format, resolution, screen size, etc. for display on a subscriber's mobile device. It will be appreciated that each media asset may be transcoded into multiple different formats so that the media asset is suitable for display on different mobile devices. In an embodiment, the transcoding occurs prior to any Digital Rights Management (DRM) protection provided for the uploaded content or media asset. For example, individual media assets may be transcoded prior to inputting into the CMS 18 or dynamically transcoded for proper rendering prior to delivery to a mobile device (e.g., the mobile device 24).

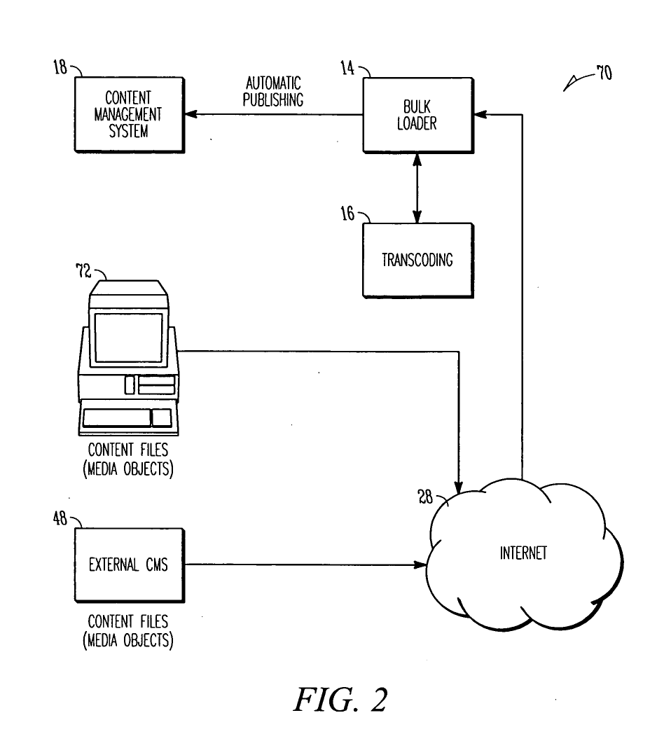

The CMS 18 may define the set of functions supporting the management of all content to be delivered to mobile subscribers. For example, the CMS 18 may maintain all information and metadata about media assets and, in an example embodiment, supports an external database or file management system containing the actual media asset files (e.g., the actual content files). FIG. 2 shows example functional entities 70 of the content publishing system 12. The functional entities 70 are shown, by way of example, to include the content management system 18, the bulk loader 14, the transcoder 16, the Internet 28, the external content management system data 48, and a remote publisher computer 72. As mentioned above, in use a content publisher may automatically publish media assets via the publisher computer 72 which are then automatically uploaded into the content management system 18 via the Internet 28 and the bulk loader 14. In an embodiment, the functional entities allow a content provider to directly (automatically and/or manually) input media assets by way of a basic file upload from any file system or storage device (e.g., the content provider computer 72). Thus, in an example embodiment, the content provider, as opposed to a content distribution network or any other parties in a content distribution chain or network, can directly publish media and may directly control the publication of media assets in a content distribution network. A content provider may thus directly ingest (and optionally remove and/or edit) media assets into a content management system. A content provider may define a policy including digital rights, pricing, or the like and when the content is automatically ingested, the policy may be automatically applied to the content.

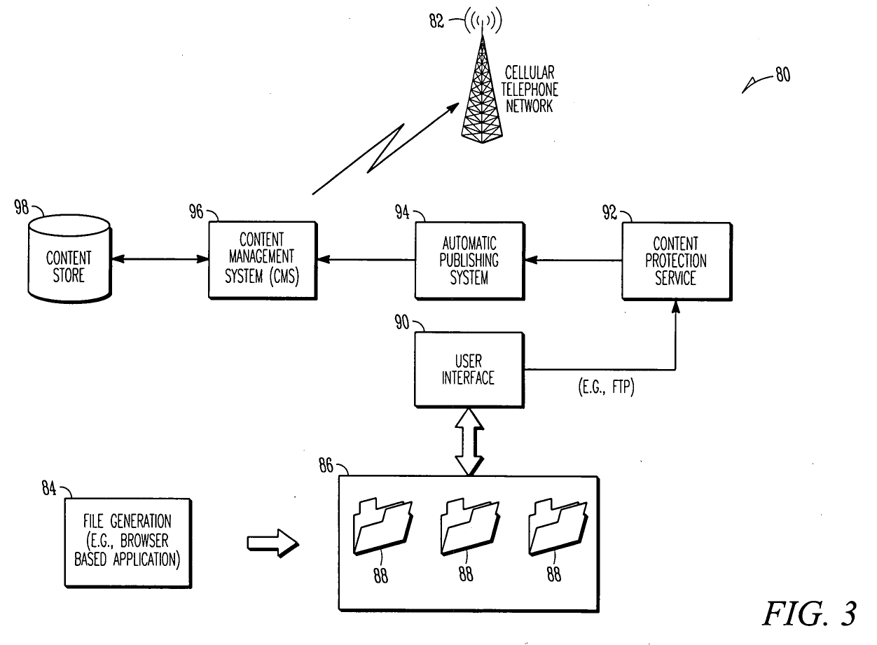

FIG. 3 shows an example system 80 in which content added to content folders is automatically ingested into a content distribution system. In particular, a content provider can use standard Windows™ functionality to drag and drop, cut/copy and paste, or the like to drop media assets into one or more folders on a remote publisher computer (e.g. the publisher computer 72 of FIG. 2). The media assets are then automatically published and made available to a plurality of mobile devices (e.g. cellular telephones) via a cellular telephone network 82. In the system 80, an upload file may be generated (e.g. using a browser based application—see block 84) on a content provider computer 72. As described in more detail below, the upload file may comprise a media asset file, a metadata file, and a configuration or control file. Accordingly, in the example embodiment, and as shown at block 86, a plurality of folders 88 may be provided on the content provider computer 72 and, using a user interface 90 the media assets in the folders 88 may be uploaded to a content protection service 92 (which may be similar to the content protection service 22 of FIG. 1). In an example embodiment, the user interface 90 is a File Transfer Protocol (FTP) interface that allows content or media assets in the folders 88 to be uploaded by way of an FTP process to the content protection service 92. The content protection 92 may then communicate the files and/or folders automatically to an automatic publishing system 94 (which may be similar to the content publishing system 12 of FIG. 1) which automatically ingests the media assets and, optionally, the metadata and control files into a content management system 96 (which may be substantially similar to the content management system 18). Thereafter, the media assets may be stored in a content store 98.

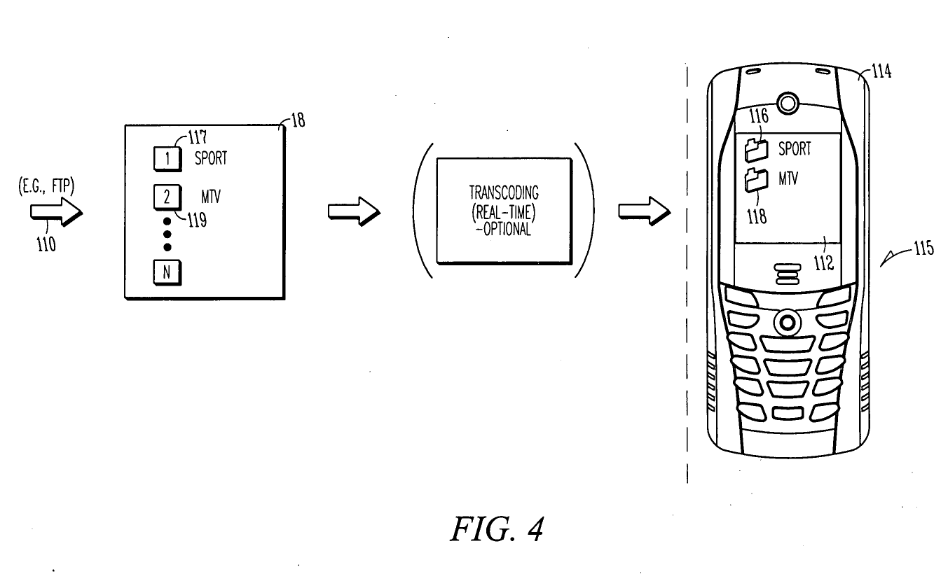

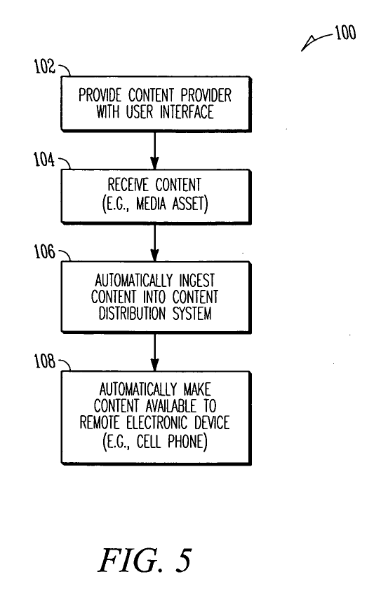

Referring in particular to FIG. 5, reference 100 shows an example method to automatically ingest and publish content in a content publishing system to at least one remote electronic device. As shown at block 102, the method 100 may provide a content provider with a user interface for receiving content or media assets. Thereafter, as shown at block 104, the method 100 may include receiving the content or media assets and automatically ingest the content into a content distribution system (see block 106). The ingested content or media assets may then be automatically made available to a plurality of remote devices (e.g. cellular telephones) as shown at block 108. The media assets may be provided by an FTP process (see arrow 110 in FIG. 4) to the content management system 96 (see FIG. 3). The content management system 96 may store the media assets or contents in folders that correspond to the folders 88 provided at the content provider and which also correspond to folders provided on a mobile device. For example, in a deployment in a cellular telephone network, the folders may correspond to those provided on a display screen 112 of a cellular telephone 114. Button of the cellular telephone 114 may be used to navigate folders, select media assets for uploading, delete media assets from the cellular telephone etc. It will be appreciated that as the content provider may create the folders 88 (see FIG. 3) and define the media assets in each of the folders 88 which correspond to those provided on the display screen 112 of the cellular telephone 114, the content provider has substantial control in presenting and publishing the media assets to users or subscribers. Thus, as shown by way of example in FIG. 4, the display screen 112 may have a sport folder 116 which corresponds to the sport folder 117 provided at the content management system 18, and an MTV folder 118 corresponding to the MTV folder 119 provided on the content management system 18. Thus, in an example embodiment, one or more folders provided at the content management system 18 may be duplicated on the cellular telephone 114. Such duplication may take via a conventional cellular telephone network e.g. the cellular network 82 of FIG. 3. It will however be appreciated that other folders may also be provided on the cellular telephone 114 and/or the content management system 18.

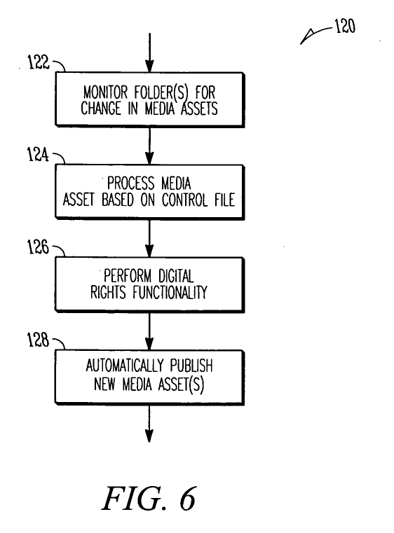

Referring in particular to FIG. 6, reference 120 shows an example of a basic method 120 to process uploaded content based on a control file. As shown at block 122, the method 120 monitors the folders (e.g. the folders 88 of FIG. 3) for a change in one or more media assets in at least one folder. For example, a new media asset may be dragged or dropped or otherwise provided in a folder 88 by a user, an existing media asset may be deleted from a folder 88, a new folder 88 may be created, and so on. Thus, a content provider may delete media assets directly from the content publishing system 12 and may create further folders (which the content provider may name appropriately and optionally at will) which are then automatically published to a remote electronic device (e.g. the cellular telephone 114). As described in more detail below, each media asset may have a configuration or control file and a metadata file associated with the media asset and, accordingly, as shown at block 124, the method 120 may process an uploaded media asset based on configuration or control data provided in an associated control file. As shown at block 126 various digital rights functionality may be performed. In an embodiment, the control file may also include data relating to the digital rights management. Once the media asset has been processed based on the control file, it may be automatically published. One or more steps of the method 120 may be performed at the content provider computer 72.

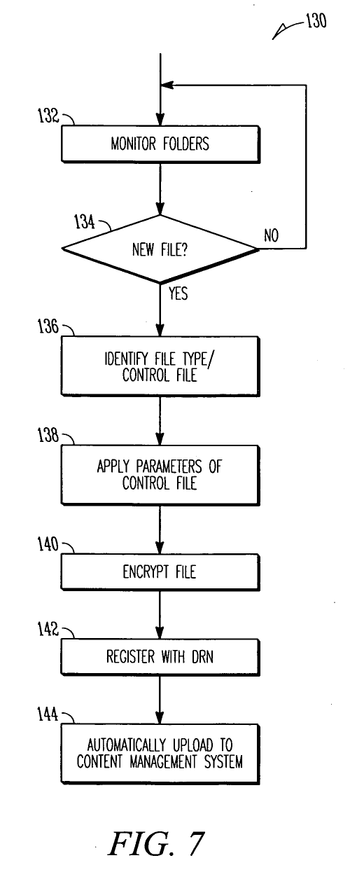

FIG. 7 shows an example of a more detailed method 130 to process uploaded content based on a control file. As shown at block 132, a monitoring process may be performed to monitor folders on a content provider computer (e.g. the content provider computer 72) to see when changes occur. Such changes may include adding a new folder, deleting a folder, moving an existing folder, or any other operations performed on a folder. The operations performed on the folder directly by the content provider may then be duplicated on the content management system 18, and on the mobile platforms such as the cellular telephone 114 in an automated fashion. Likewise, any functions performed with respect to a file on the content provider computer 72 may be monitored including, but not limited to, creation of a new media asset file, deleting an existing media asset file, or the like. Thus, when the content provider is desirous of deleting content from the networked system 10 and thus the content is no longer available to a user, the file or media asset may merely be deleted by the content provider whereafter the system 10 automatically removes the content. Likewise, as described above, new media assets may be dropped into a folder and be automatically published.

Thus, when monitoring a new file, as shown at decision block 134, the method 130 may, upon detecting a new file has been added to a folder, proceed to block 136 where the particular file type may be identified (e.g. an audio file, wallpaper for a cellular telephone, a text file, a ring tone, or any other file type that may require uploading) and a control file associated with a media file is then also identified. Thereafter, as shown at block 138, the method 130 applies the parameters of the control file to the media file and the file is then encrypted (see block 140). Following encryption of the media file, the media asset is then registered with a digital rights network or media authorization network (e.g. the media authorization network 52 of FIG. 1) as shown at block 142. Thereafter, the media asset is automatically uploaded or ingested into the content management system (e.g. the content management system 18 of FIG. 1) as shown at block 144.

In an example embodiment, two user-friendly Application Program Interfaces (APIs) may be provided. A manual API may be provided that enables a content provider to manually upload a media asset (e.g., by clicking on an ‘Upload’ button of a graphical user interface) along with a metadata file (e.g., defining and describing the media asset and including other parameters on how the media asset is to be used) to be simply dropped into a file folder for publication. An automatic API may be provided that enables a media asset along with an associated metadata file to be received from an external system (such as an external content management system) and automatically insert or place the media asset into a file folder at the content management system 18 for publication. The manual and/or automatic API may allow one or more files to be loaded in bulk.

In an embodiment, an interface in the form of a server-side API of the content publishing system 12 may interface with an automatic publishing application provided on the remote content provider computer 72. The server-side API may periodically communicate with the remote content provider computer 72 to identify content changes, and automatically update content stored in the media server 20 based on the communication.

Returning to the method 130 at block 132, a process may be used to periodically scan the folders for new media files and new metadata files that are not already published in the system 10, or that are published and can be overwritten (e.g., deleted, changed, edited etc.). When new media files are found or detected, they may be optionally processed through a transcoder so as to covert them into a format for proper rendering on different mobile devices. Thus, the media file may be processed so that it is suitable for display on one or more specific platforms or on a particular model of the electronic device (e.g., a cellular telephone model available from a particular manufacturer). Parameters for the transcoding may be provided by control data in a control file associated with the media file. The transcoded content or media asset, along with associated the metadata, may then be ingested (see block 144). In an embodiment, the content management system 18 may associate the published content or media asset with an appropriate end-user application which may be provided as a Wireless Application Protocol (WAP) application or downloadable client on the mobile device 24. WAP may allow users to access information almost ‘instantly’ via handheld wireless devices such as mobile phones, pagers, two-way radios, smart phones, communicators, or the like (herein included under the term ‘electronic or mobile device’). The system 10 may thus accommodate most wireless networks which, for example, may include CDPD, CDMA, GSM, PDC, PHS, TDMA, FLEX, ReFLEX, iDEN, TETRA, DECT, DataTAC, Mobitex, or any other wireless network.

In an embodiment, the cellular telephone 114 provides access to the Internet using, for example, a microbrowser. Microbrowsers include browsers with small file sizes that may accommodate low memory constraints of handheld devices and low-bandwidth constraints of a wireless-handheld network. In an embodiment, a markup language may be used that it is suitable for small screens and one-hand navigation without an extensive keyboard. It will be appreciated that the content may be rendered using various other techniques such Java applications, Brew applications, or any client applications that are provided on the mobile device (preloaded or downloaded). In a relatively fast cellular telephone network, downloading of files may take place in a matter of seconds, allowing content to be simply dropped into a folder at the content provider computer 72, automatically ingested and published into the content management system 18, and subsequently automatically displayed for use by a mobile subscriber. In an embodiment, content can be unpublished from the system 10 by removing it from a folder (e.g., a folder 88) that it was originally placed into, thereby removing its accessibility from the mobile application.

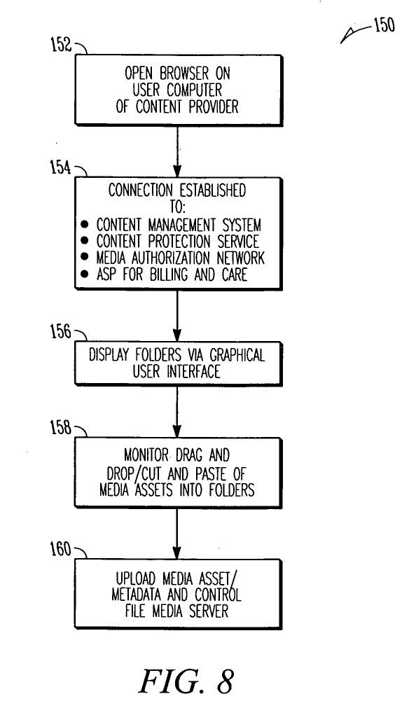

Referring in particular to FIG. 8, shows an example method 150 of adding content to a content folder using a browser-based graphical user interface. As shown at block 152, a content provider may open a browser (e.g., Windows Explorer, Firefox by Mozilla, or the like) on a user computer (e.g. a content provider computer 172). Thereafter, as shown at block 154, a connection may be established between the content provider computer 172 and a content publisher (e.g. the content publishing system 12 of FIG. 1). When deployed in the system 10, a connection may be established to the content management system 18, the content protection service 22, the media authorization network 52, and the ASP module 56 including the customer care management module 57 and the billing management module 58.

The browser may then display folders (e.g. folders 88 in FIG. 3) via a graphical user interface (see block 156). Thereafter, the method 150 may monitor drag and drop, cut/copy and paste, or any other functionality wherein a user may provide a media file in a target or destination folder (see block 158). User activity may be monitored and, upon a change in a content file or media asset in a particular folder, the changes may be uploaded (see block 160) to the content publishing system 12. In particular, one or more media files and their associated metadata files and or control files may be updated to a media server 20.

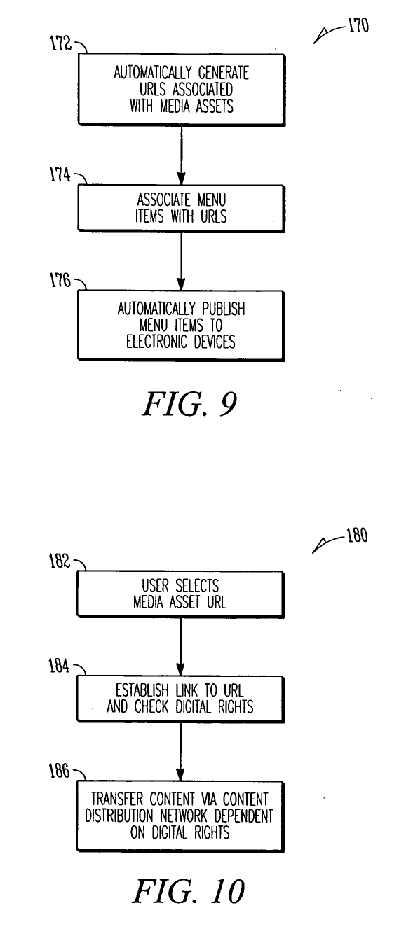

FIG. 9 shows an example 170 method of automatically publishing the availability of content ingested into the content distribution network where the content is downloadable using a URL. As shown at block 172, when the content publishing system 12 receives the media assets from the content provider, URL's associated with the media assets may be automatically generated by the content publishing system 12 (see block 172). Thereafter, as shown at block 174, menu items (e.g. folders, icons or any other identifiers) may be associated with the URLs. The menu items or folders (e.g. a sport folder, an MTV folder, or the like) may be automatically published (see block 176) via the system 10 to a plurality of electronic devices such as the mobile device 24. In order for a user to acquire a selected media asset, a method 180 (see FIG. 10) includes monitoring user selection of a media asset which has an associated URL (see block 182). When a user clicks on a selected URL, a link is established and digital rights associated with the media asset and with the user are then determined (see block 184). After the digital rights have been ascertained, and assuming that the user is authorized to access the content, the media asset is then transferred via a wireless communication network (e.g. a cellular telephone network) to a mobile device 24 such as a cellular telephone (see block 186). Thus, a content provider may automatically publish their content via the system 10 without any intervention by personnel of a content distribution system or any other members of a distribution channel.

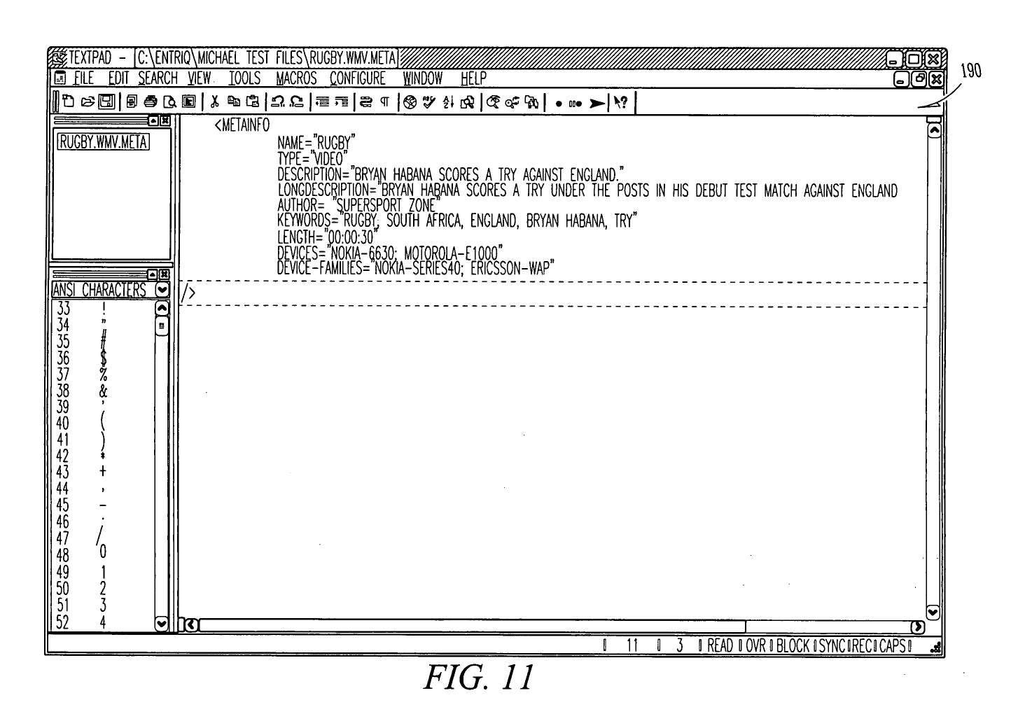

As mentioned above, each media file may include an associated metadata file and an associated control file. FIG. 11 shows an example graphical user interface showing metadata associated with a media asset. For example, the media file may be a video file including a video clip. Accordingly, the metadata file (e.g., an XML file) may then include a name of the video clip (e.g. ‘Rugby’) as well as the type of media provided in the file (e.g. ‘video’). In addition, a description may be provided that describes the nature of the content of the media file (e.g., ‘Bryan Habana scores a try against England’). In an embodiment, charging details or charge codes maybe provided (e.g., provider_service_id_field) and a length of the video may also be provided. In an embodiment, the metadata file may also include details of one or more devices on which the media has been transcoded or rendered suitable for reproduction. For example, in FIG. 11, the video clip may be suitable for a Nokia-6630 cellular telephone, a Motorola E-1000 cellular telephone, or any other device families specified in a device family field. A graphical user interface may be provided to the content provider which allows the content provider to enter metadata associated with a media as for a media file for publication. In an embodiment, a metadata file and/or control file may be generated using a software wizard and it will be appreciated that any metadata that the content provider deems appropriate may be included in the metadata file.

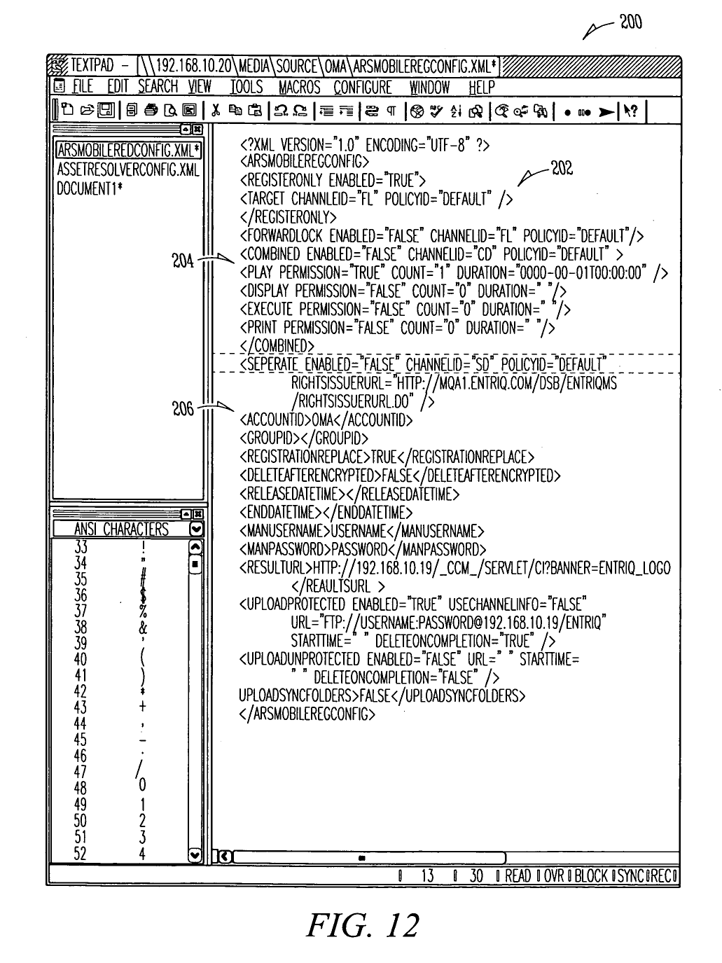

Referring to FIG. 12, an example of a graphical user interface 200 of control data associated with a folder including one or more media assets is shown. In an example, a control file is provided that includes control data that may, for example, include policy data. The policy data may include identifying digital access rights associated with the content or media asset, identifying an electronic platform on which the content is configured for playback, identifying a geographical area for distribution of the content, identifying how the content is to be delivered, managing presentment of the content on the electronic device, transcoding instructions, and/or the like. In an example embodiment, the control file is associated with a folder and, in these examples circumstances, any media file placed into the folder would then have the specific control data or control file associated with the associated folder. Accordingly, control data that may include complex parameters may be determined by a content distribution network and provided to a content provider thereby allowing a content provider merely to place a media file or asset in the folder which would then automatically be configured as required. For example, if the media asset is a video clip, the control file may include processing data to process the media file. In the example control file shown in the graphical user interface 200, channel identification data and policy identification data (see arrow 202) may be provided, various permissions may be defined (see arrow 204), an account may be identified (see arrow 206), user name and password details and any other policy related or digital rights related parameters may be defined. It will however be appreciated that the control file may also be generated by the content provider using, for example, a wizard. Thus, control data may be provided or defined by the content provider (e.g., via the content provider computer 72) and/or by the content publishing system 12. In an embodiment, the control data includes sequencing data that controls the sequence of playback of a plurality of media assets on a remote electronic device.

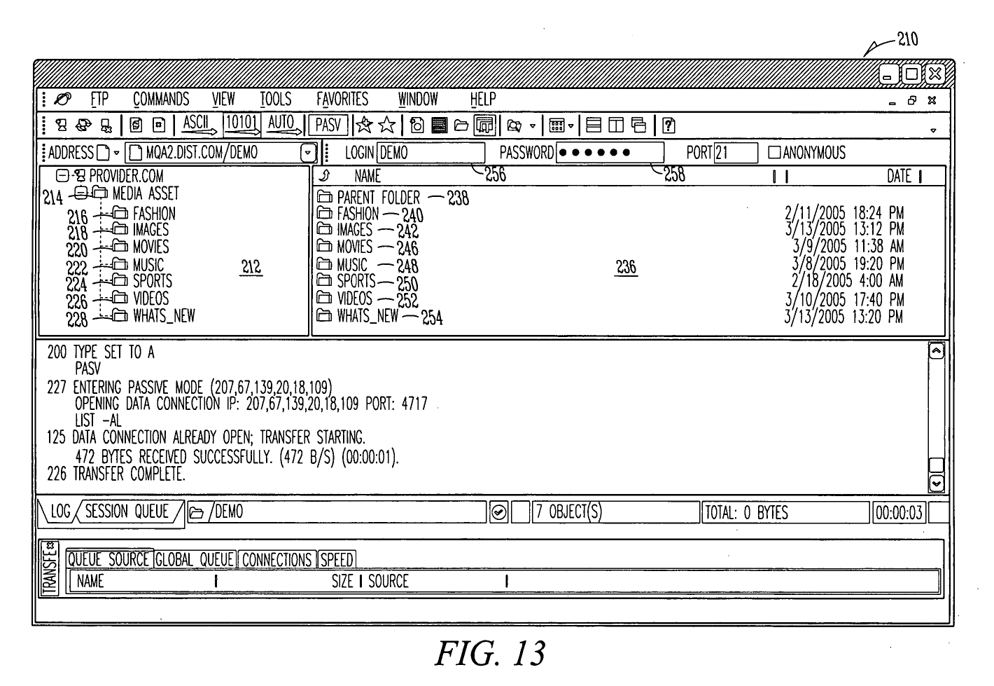

FIGS. 13 to 16 show example graphical user interfaces (GUIs) that allow a content provider to automatically publish media assets to a plurality of electronic devices (e.g. mobile devices 24). FIG. 13 shows an example graphical user interface 210 that may be presented to a content provider (e.g. at a content provider computer 72) to automatically upload and publish content via the networked system 10. A display area 212 allows a user or content provider to navigate one or more directories on a content provider computer 72. In the example GUI 210 of FIG. 13, an example folder ‘Media Asset’ 214 is shown by way of example to include a plurality of subfolders. The subfolders may, by way of example, include a ‘fashion’ subfolder 216, an ‘images’ subfolder 218, a ‘movies’ subfolder 220, a ‘music’ subfolder 222, a ‘sports’ subfolder 224, a ‘videos’ subfolder 226, and a ‘whats_new’ subfolder 228. It will be appreciated that other or further subfolders may be provided in different embodiments and that, at any time, a content publisher may edit these subfolders, add a subfolder, remove a subfolder, rename a subfolder, or the like. As mentioned above, the display area 212 may show folders available on a local computer. A display area 236 may also be provided that shows folders provided at a content publishing system 12, for example, on the content management system 18. In the example GUI 210, a ‘Parent Folder’ 238 is provided and several other folders corresponding to those provided at the content provider computer 72 are also provided. In particular, by way of example, a corresponding ‘fashion’ folder 240, an ‘images’ subfolder 242, a ‘movies’ subfolder 246, a ‘music’ subfolder 248, a ‘sports’ subfolder 250, a ‘videos’ subfolder 252, and a ‘whats_new’ subfolder 254 are shown. In an example embodiment, the folders provided at the content publishing system 12 correspond to those provided at the content provider computer 72. Further, in an embodiment, the networked system 10 replicates or duplicates any function or operation performed in the folders 214 to 228 on the content provider computer 72 to the folders 240 to 254 provided at the content publishing system 12. For example, if a user adds or deletes a media file in the ‘images’ subfolder 218, the same action is then performed in the corresponding ‘images’ folder 242 at the content publishing system 12. As also shown in the GUT 210, login details 256 and a password 258 may be required to allow the content provider to publish or modify content.

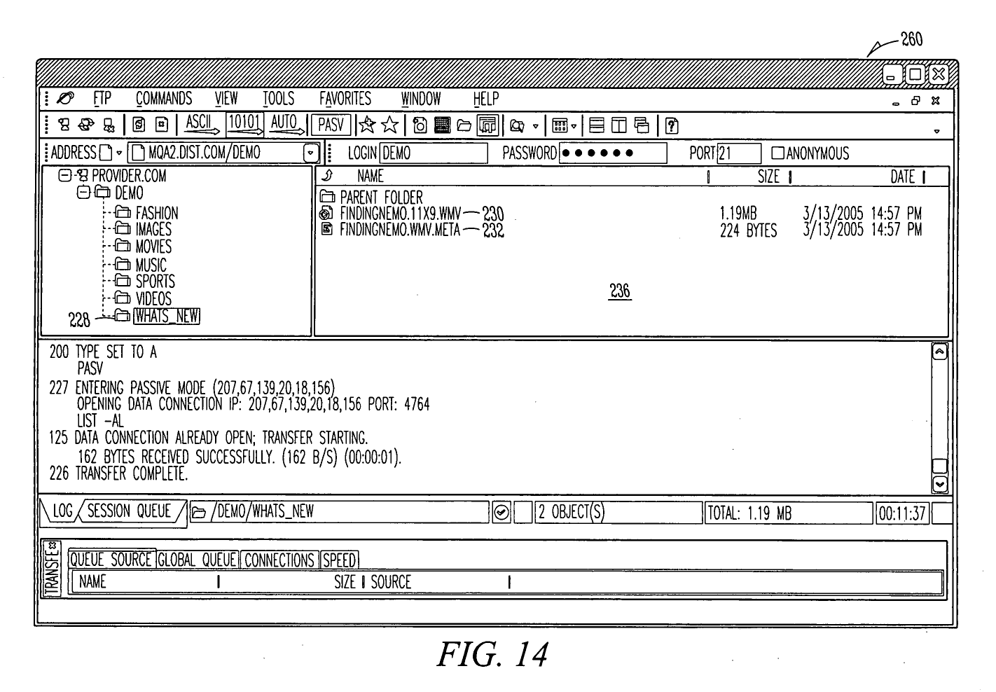

FIG. 14 shows an example graphical user interface 260 where a new media asset has been added to a content publishing system for automatic publishing. In the example GUI 260 a new media asset has been added to the ‘whats_new’ folder 228. In particular, a video clip ‘Finding Nemo’ has been added by cutting and pasting the media file into the display area 236 of the content management system 18. Further, a metadata file 232 associated with the media file 232 is also provided. As described herein before, once a user has cut and pasted or otherwise provided the media file 230 in the content management system display area 236, the media file 230 is then automatically ingested into the content publishing system 12.

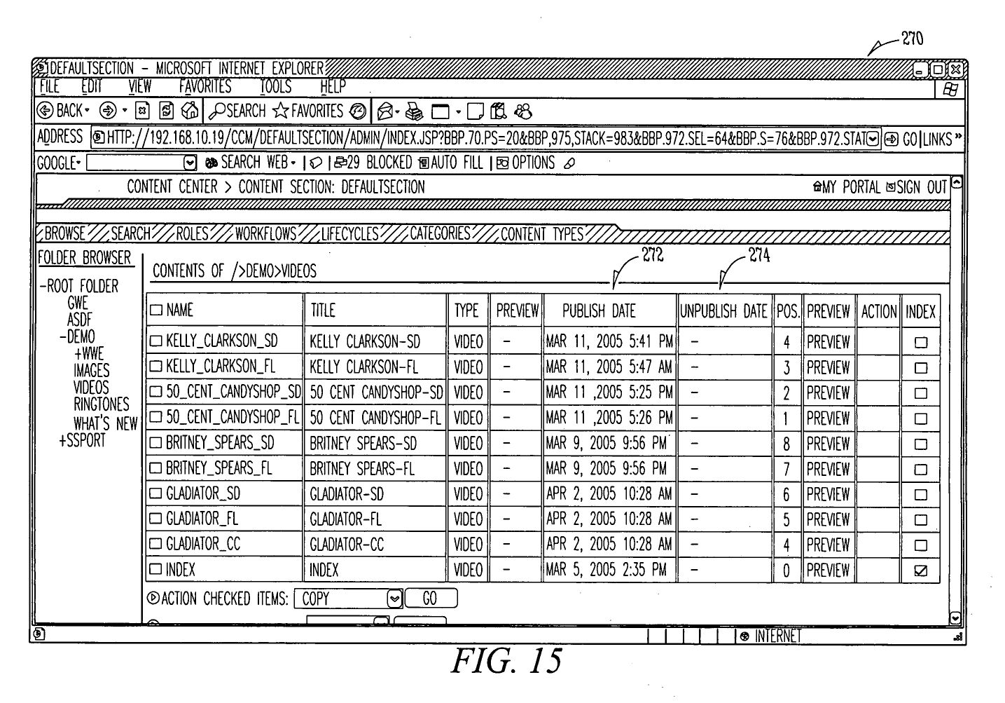

FIG. 15 shows an example graphical user interface 270 of a content management system prior to publishing a new media asset. The GUI 270 may be provided for the content management system 18 to allow a new media asset to be published via the content distribution server 30. In the example GUI 270, the media assets are in the form of a plurality of video clips of various artists. As shown in column 272, details of when a particular media asset were published (or are to be published) may be provided and, when each media asset is unpublished on deleted from the networked system 10, a corresponding date may be shown in column 274. Thus, details of media available for publishing may be perused.

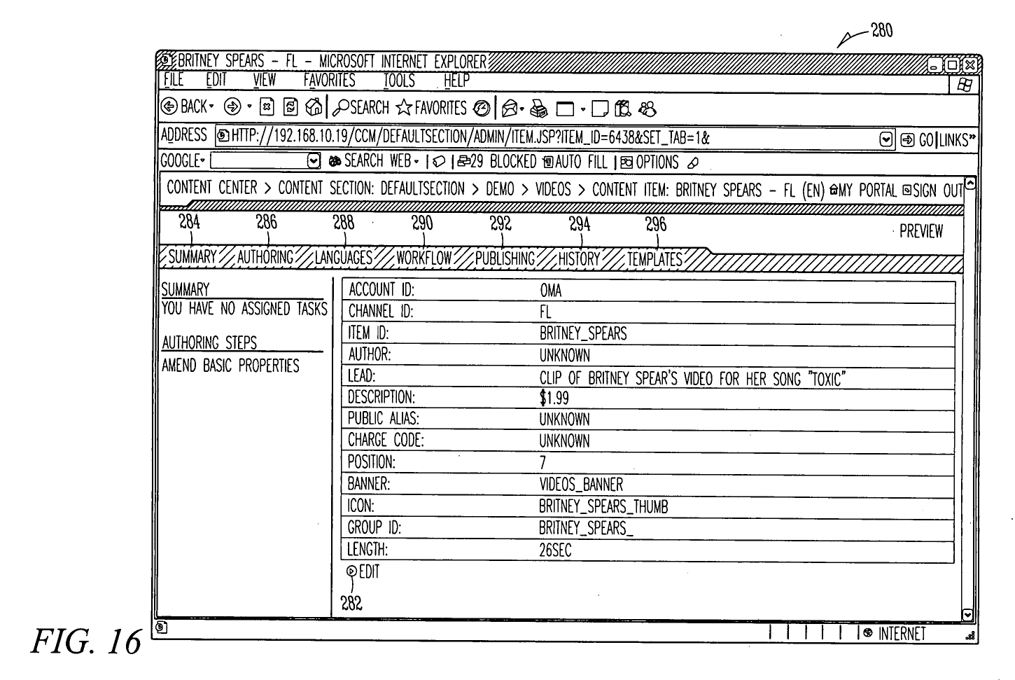

FIG. 16 shows a graphical user interface 280 that provides details of metadata associated with a particular media asset. In an embodiment, the GUI 280 may allow a user to edit the metadata as shown by edit button 282. Thus, the metadata shown in FIG. 11 may also be displayed via the GUI 280. In an embodiment, the GUT 280 includes a plurality of tabs that allow a content publisher to perform various functions. For example, the GUI 280 may include a “Summary” tab 284, an ‘Authoring’ tab 286, a ‘Languages’ tab 288, a ‘Workflow’ tab 290, a ‘Publishing’ tab 292, a ‘History’ tab 294, and a ‘Templates’ tab 296. The ‘Summary’ tab 284 may provide summaries of all content provided or published by a particular content provider, the ‘Authoring’ tab 286 may allow the content provider to edit and author details associated with a media file, the ‘Languages’ tab 288 may allow content or media assets to be published in various different languages, the ‘Workflow’ tab 290 (e.g., approval by a manager or other party), the ‘Publishing’ tab 292 may publish data to the content publishing system 12, the ‘History’ tab 294 may allow a user to view past history of content published by the content provider 12, and the ‘Templates’ tab 296 may allow a user or content publisher to select various templates and enter data therein which is then associated with a media file to be published.

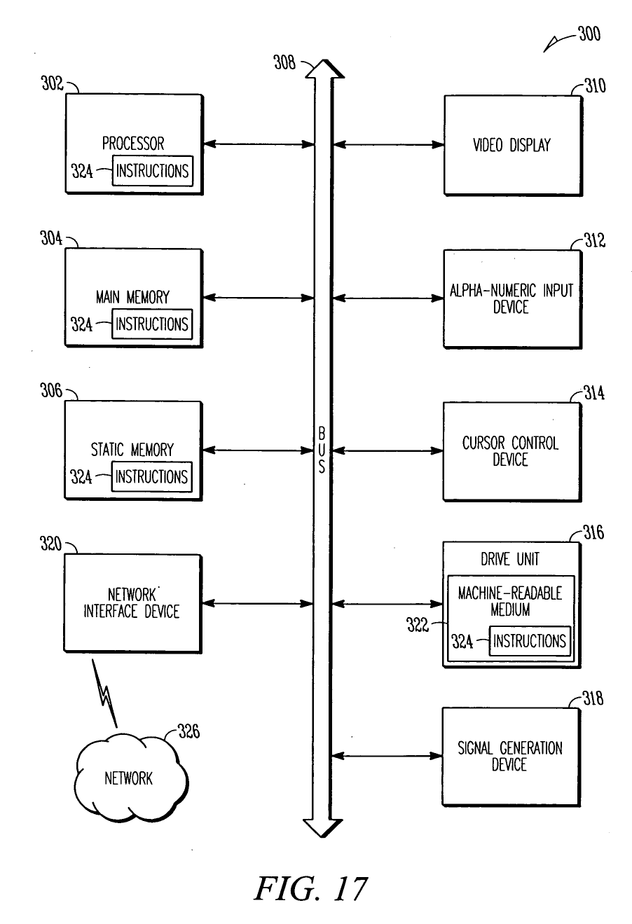

FIG. 17 shows a diagrammatic representation of machine in the example form of a computer system 300 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term ‘machine’ shall also be taken to comprise any collection of machines that individually or jointly execute a set (or multiple sets) of instructions to perform any one or more of the methodologies discussed herein.

The example computer system 300 comprises a processor 302 (e.g., a central processing unit (CPU) a graphics processing unit (GPU) or both), a main memory 304 and a static memory 306, which communicate with each other via a bus 308. The computer system 300 may further comprise a video display unit 310 (e.g., a liquid crystal display (LCD) or a cathode ray tube (CRT)). The computer system 300 also comprises an alphanumeric input device 312 (e.g., a keyboard), a cursor control device 314 (e.g., a mouse), a disk drive unit 316, a signal generation device 318 (e.g., a speaker) and a network interface device 320.

The disk drive unit 316 comprises a machine-readable medium 322 on which is stored one or more sets of instructions (e.g., software 324) embodying any one or more of the methodologies or functions described herein. The software 324 may also reside, completely or at least partially, within the main memory 304 and/or within the processor 302 during execution thereof by the computer system 300, the main memory 204 and the processor 302 also constituting machine-readable media.

The software 324 may further be transmitted or received over a network 326 via the network interface device 320.

While the machine-readable medium 322 is shown in an example embodiment to be a single medium, the term ‘machine-readable medium’ should be taken to comprise a single medium or multiple media (e.g., a centralized or distributed database, and/or associated caches and servers) that store the one or more sets of instructions. The term ‘machine-readable medium’ shall also be taken to comprise any medium that is capable of storing, encoding or carrying a set of instructions for execution by the machine and that cause the machine to perform any one or more of the methodologies of the present invention. The term ‘machine-readable medium’ shall accordingly be taken to comprise, but not be limited to, solid-state memories, optical and magnetic media, and carrier wave signals.

Thus, a method and system automatically publish digital media have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A method to publish content for at least one remote electronic device, the method including:
providing a content provider with an interface to directly provide content for publishing by a content publishing system;
automatically ingesting the content into the content publishing system; and
automatically making the content available to the remote electronic device.

2. The method of claim 1, which includes making the content available via a wireless data network to a plurality of electronic devices.

3. The method of claim 2, wherein the content are media assets selected from the group including audio, ring tones, video, and wallpaper.

4. The method of claim 1, wherein the interface is a graphical user interface and the method includes:
providing a display window for receiving the content;
monitoring a user action in which content in placed in the display window; and
automatically uploading the content to the content publishing system.

5. The method of claim 4, wherein the display window includes at least one folder and the user action is a drag-and-drop action or cut-and-paste action facilitated by a computer operating system and wherein the content is provided in a file.

6. The method of claim 5, which includes:
allowing the user to create and delete folders and files in the window; and
updating corresponding folders and files in the content publishing system.

7. The method of claim 5, which includes associating control data with the folder, the control data controlling use of the content.

8. The method of claim 7, wherein the control data includes policy data including one of identifying digital access rights associated with the content, identifying a electronic device platform on which the content is configured for playback, identifying a geographical area for publishing of the content, identifying how the content is to be delivered, managing presentment of the content on the electronic device, and transcoding instructions.

9. The method of claim 7, wherein the control data includes sequencing data that controls the sequence of playback of a plurality of media assets on a remote electronic device.

10. The method of claim 1, wherein content in the form of a digital asset is provided in a media file, the media file including an associated a control file including the control data associated at least with the media file and a metadata file metadata file providing metadata pertaining to the media file.

11. The method of claim 1, wherein the interface is a web-interface and the method including ingesting the content from a remote content provider terminal via the Internet utilizing an FTP process.

12. The method of claim 1, wherein the interface is a server-side API of the content publishing system that interfaces with an automatic publishing application provided on a remote content provider computer.

13. The method of claim 12, which includes:
periodically communicating with the remote content provider computer to identify content changes; and
automatically updating content stored to a media server based on the communication.

14. The method of claim 13, wherein a plurality of folders that include media assets are provided on the remote content provider computer, and the automatically updating includes uploading the media assets to corresponding folders on the media server.

15. The method of claim 1, which includes:
automatically ingesting the content in the form of a media asset into a folder at a media server of the content publishing system;
providing links to the media asset to a plurality of remote electronic devices;
monitoring a request for the media asset from at least one of the remote electronic devices;
selectively communicating the media asset to the at least one electronic device based on digital media rights associated with the at least one electronic device.

16. The method of claim 15, which includes:
storing the media asset in a media store of a content management system; and
automatically creating a link to the media asset in the store when the media asset is ingested into the content publishing system.

17. The method of claim 1, which includes:
providing a graphical user interface to a content provider to enter metadata associated with content in the form of a media asset;
monitoring entry of metadata associated with a media asset;
generating a metadata file associated with the media asset; and
associating a control file with the media asset, the control file controlling use of the media asset.

18. The method of claim 1, which includes:
providing a graphical user interface to a content provider to enter control data associated with content in the form of a media asset;
monitoring entry of the control data associated with a media asset via the graphical user interface; and
generating a control file associated with the media asset, the control file controlling use of the media asset.

19. The method of claim 18, wherein the control data includes policy data including one of identifying digital access rights associated with the content, identifying a electronic device platform on which the content is configured for playback, identifying a geographical area for publishing of the content, identifying how the content is to be delivered, managing presentment of the content on the electronic device, and transcoding instructions.

20. The method of claim 1, which includes making the content available via a cellular telephone network to a plurality of electronic devices in the form of cellular telephones.

21. A machine-readable medium including instructions which, when executed by a machine, cause the machine to perform the method of claim 1.

22. A content publishing system to publish content for at least one remote electronic device, the system including:
a content provider interface to directly receive content from a content provider for publishing by the content publishing system; and
a media server into which the content is automatically ingested, wherein the content is automatically made available to the at least one remote electronic device.

23. The system of claim 22, which includes:
a content database to store metadata associated with the received content; and
a content management system providing the content provider interface, the metadata being received directly from a content provider via the Internet.

24. The system of claim 23, which includes:
a transcoder to transcode the received content and render transcoded content suitable for communication to the at least one electronic device; and
a media database to store the transcoded content.

25. The system of claim 22, which includes a content protection service accessible by a remote content provider, the content protection service being to communicate with a media authorization network.

26. The system of claim 22, which includes a device profile management system to store profile data associated with the at least one remote electronic device.

27. The system of claim 22, which includes a channel distribution server in communication with a media server and operable to content via a wireless communication network to a plurality of remote mobile electronic devices.

28. The system of claim 27, wherein the wireless communication network is a cellular communication network and the plurality of remote mobile electronic devices are cellular telephones.

29. A content publishing system to publish content for at least one remote electronic device, the system including:
means for providing a content provider with an interface to directly provide content for publishing by a content publishing system;
means for automatically ingesting the content into the content publishing system; and
means for automatically making the content available to the remote electronic device.
